(19) United States
(12) Patent Application Publication
(10) Pub. No.: US 2013/0106865 A1
(43) Pub. Date: May 2, 2013

(54) DEVICE, METHOD AND COMPUTER PROGRAM PRODUCT

(71) Applicant: Anders Bertram Eibye, Copenhagen (DK)

(72) Inventor: Anders Bertram Eibye, Copenhagen (DK)

(73) Assignee: SONY ERICSSON MOBILE COMMUNICATIONS AB, Lund (SE)

(21) Appl. No.: 13/141,826

(22) PCT Filed: Jul. 23, 2010
(86) PCT No.: PCT/EP10/60693

§ 371 Date: Dec. 19, 2011

(51) Int. Cl. G06T 11/00

(52) U.S. Cl. CPC G06T 11/00
USPC 345/467

(57) ABSTRACT

Device (36) for analyzing and modifying on-screen handwriting. The device (36) is arranged to determine at least one characteristic (14,16, 18, 20, 22, 24) of at least one section of handwriting (10), modify said at least one characteristic (14, 16, 18, 20, 22, 24) and generate modified on-screen handwriting data (34).

### TECHNICAL FIELD

The present invention concerns a device, method and computer program product for analyzing and modifying on-screen handwriting, i.e. digital handwriting that is to be presented on a display means of a device.

### BACKGROUND OF THE NVENTION

Devices are known which are able to receive and interpret intelligible handwritten input from sources such as paper documents, photographs, touch screens and other devices. The image of the written text may be sensed “off line” from a piece of paper by optical scanning (optical character recognition) or intelligent word recognition (which recognizes entire handwritten words or phrases instead of single optical characters). Alternatively, the movements of a stylus pen tip on a screen surface may be sensed “on line”.

The sensed handwritten input obtained by such a device may be displayed on a display screen of the device into which the handwriting was inputted, or transmitted to the display screen of another device for display. A person's individual handwriting style may therefore be accurately presented on-screen, Such an accurate representation of a person's handwriting on a display screen poses no problems for a reader if that person's handwriting is neat and legible. Problems in reading on-screen handwriting may however occur if the handwriting is untidy or illegible.

### SUMMARY OF THE INVENTION

An object of the invention is to overcome or ameliorate at least one of the disadvantages of the prior art, or to provide a useful alternative thereto. A further object of the present invention is to provide a device for analyzing and modifying on-screen handwriting in order to make on-screen handwriting tidier and more aesthetically pleasing, and perhaps consequently more legible and/or easy to read, while still maintaining something of the author's personal handwriting style.

At least one of these objects is achieved by a device that is arranged to determine at least one characteristic of at least one section of handwriting, modify the at least one characteristic and generate modified on-screen handwriting data, in the form of a modified handwriting vector for example.

Such a device may be arranged to receive or obtain handwritten input from a source such as a paper document, photograph, touch screen or any other device. For example, the movements of a finger or a stylus, a pen-shaped pointing device for example, on a screen may be sensed to produce a pattern of the pixels over which the finger/stylus has been moved. At least one characteristic selected from the group: letter/symbol angles (a symbol being a number, sign, object or mathematical operator or quantity), letter/symbol spacings, letter/symbol loops, letter/symbol size (height, width, thickness), word spacings, line spacings, stroke style, stroke weight and/or baseline position, of at least one section of the received/obtained handwriting is determined.

For example, the spacings between words in the at least one section of handwriting may be measured/determined and then modified to be the same throughout the on-screen handwriting, or to lie within a pre-determined range so as to exhibit a certain level of similarity/consistency. The modified on-screen handwriting will consequently be more aesthetically pleasing and easier to read, thereby improving communication efficiency.

For example, all letter/symbol angles, spacings and sizes may be modified to be the same throughout the handwriting and all letter/symbol loops may be modified to have the same form, for example the number “0” and the letter “O” may be modified to always form a closed loop. The general handwriting style may be modified so that all characters are connected together and/or undesired features, such as undesired line intersections and kinks in loops or lines are mitigated. Modified on-screen handwriting data is then generated, optionally substantially at the same time as a user is inputting handwriting. The modified on-screen data may for example have the same spacing between words and contain letters of the same height and thickness, sloping at the same angle form the base line and having the same loop style. The on-screen handwriting may also be modified to look as though it was written using a felt-tip pen, ballpoint pen, calligraphy pen or pencil for example.

There are many algorithms that a skilled person may use to modify at least one characteristic of the at least one section of handwriting and generate modified on-screen handwriting data. These algorithms may be user-interactive or non-user-interactive whereby in the first case a user may be given the option of how the at least one characteristic is modified.

It should be noted that the device according to the present invention may optionally comprise optical character recognition and/or intelligent word recognition means and/or means to automatically convert inputted handwriting into letter codes which are usable within computer and text-processing applications. The device may also be arranged to offer text-processing applications such as a spell checking application. The device according to the present invention is however preferably arranged not to execute handwriting recognition but to merely analyze at least one characteristic of inputted handwriting and effect the display of more aesthetically pleasing on-screen handwriting in which at least one characteristic has been modified but which still reflects a user's personal handwriting style. Since the characters and words do not need to be recognized or understood, modified on-screen handwriting may be displayed much more quickly, preferably immediately almost in real time. It should be noted that the device according to the present invention may be arranged to replace handwritten characters with the characters of a standardized font. However the device is preferably arranged to maintain something of the author's personal handwriting style without replacing handwritten characters with the characters of a standardized font.

According to an embodiment of the invention the device comprises inputting means, such as a digitizer, or a stylus and touch sensitive surface, for inputting the at least one section of handwriting. The inputting means may be integrated with, or adjacent to, a display means. Alternatively or additionally the device is arranged to receive input representative of at least one section of on-screen handwriting from another device or from a computer-readable medium or a carrier wave for example.

According to a further embodiment of the invention the device is arranged to store the modified on-screen handwriting data either within the device itself or in storage means external to the device. The stored modified on-screen handwriting data may be associated with a particular user and subsequently re-used once a particular user has been identified. A user's preferences of how he/she would like his/her on-screen handwriting to look may namely be stored and applied each time the user inputs or provides handwriting to be analyzed and modified.

According to another embodiment of the invention the device is included in a mobile telephone, media player, Personal Communications System (PCS) terminal, Personal Data Assistant (PDA), laptop computer, palmtop receiver, a file server, camera, television, radar or any appliance that includes a transducer designed to transmit and/or receive radio, television, telephone and/or radar signals.

The present invention also concerns a method for analyzing and modifying on-screen handwriting. The method comprises the steps of determining at least one characteristic of at least one section of handwriting, modifying the at least one characteristic and generating modified on-screen handwriting data.

According to an embodiment of the invention the method comprises the step of inputting the at least one section of handwriting.

According to another embodiment of the invention the method comprises the step of receiving input representative of at least one section of handwriting.

According to a further embodiment of the invention the method comprises the step of displaying modified on-screen handwriting.

According to an embodiment of the invention the method comprises the step of storing the modified on-screen handwriting data.

According to another embodiment of the invention the at least one characteristic is selected from the group: letter symbol/angles, letter/symbol spacings, letter/symbol loops, letter/symbol size, word spacings, line spacings, stroke style, stroke weight, baseline position.

The present invention also concerns a computer program product that comprises a computer program containing computer program code means arranged to cause a computer or a processor to execute the steps of a method according to any of the embodiments of the invention, stored on a computer-readable medium or a carrier wave.

### BRIEF DESCRIPTION OF THE DRAWINGS

The present invention will hereinafter be further explained by means of non-limiting examples with reference to the appended schematic figures where;

FIG. 1 shows handwriting input for a device according to an embodiment of the present invention,

FIG. 2 shows how on-screen handwriting may be modified by a device/method or computer program product according to an embodiment of the invention,

FIG. 3 shows the steps of a method according to an embodiment of the invention, and

FIG. 4 shows a device according to an embodiment of the invention.

It should be noted that the drawings have not been drawn to scale and that the dimensions of certain features have been exaggerated for the sake of clarity.

### DETAILED DESCRIPTION OF EMBODIMENTS

FIG. 1 shows a section of handwriting 10 that may be analyzed and modified by a device according to an embodiment of the invention. The handwriting 10 may be produced using a finger or stylus and a touch sensitive surface, whereby a software application which interprets the movements of the finger or stylus across the surface, translates the resulting strokes into digital text. Alternatively, a user may produce the handwriting by writing on a piece of paper with a pen or pencil, whereupon the handwriting is scanned to produce digital text and supplied to a device according to the present invention.

At least one characteristic of the handwriting 10 such as letter symbol/angles 12 with respect to a baseline 14, letter/symbol spacings 16, letter/symbol loops 18, letter/symbol size 20, word spacings 22, line spacings 24, stroke style, stroke weight and/or baseline position is determined. This characteristic is modified throughout preferably the entire section of handwriting 10 so that modified on screen handwriting may be generated. For example, the word spacings 22 may be measured and then changed to correspond to the average word spacing throughout the modified on-screen handwriting. The modified on-screen handwriting data is generated. Modified on-screen data may then be displayed immediately, substantially in real time, on the device into which the handwriting 10 has been inputted, or may be wirelessly or non-wirelessly transmitted to be displayed on another device or a plurality of devices.

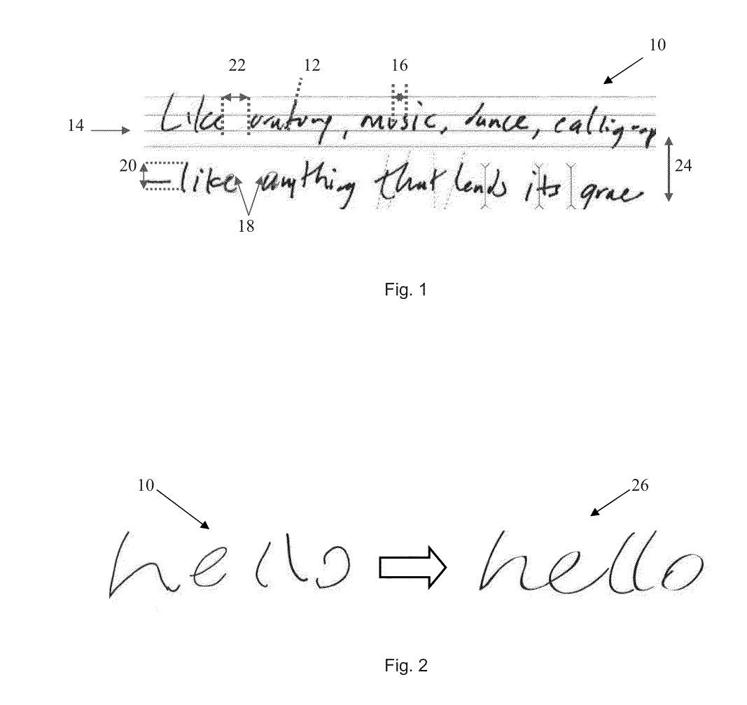

FIG. 2 shows a section of handwriting 10 which has been inputted or supplied to a device according to the present invention and that section of handwriting 26 after it has been analyzed and modified by the device. The modified on-screen handwriting 26 comprises substantially uniformly spaced letters of substantially the same size which lie on the same baseline and slope at the same angle with respect to the baseline. The modified on-screen handwriting 26, while substantially preserving the personal handwriting style of the author, has thereby been made easier to read and more legible.

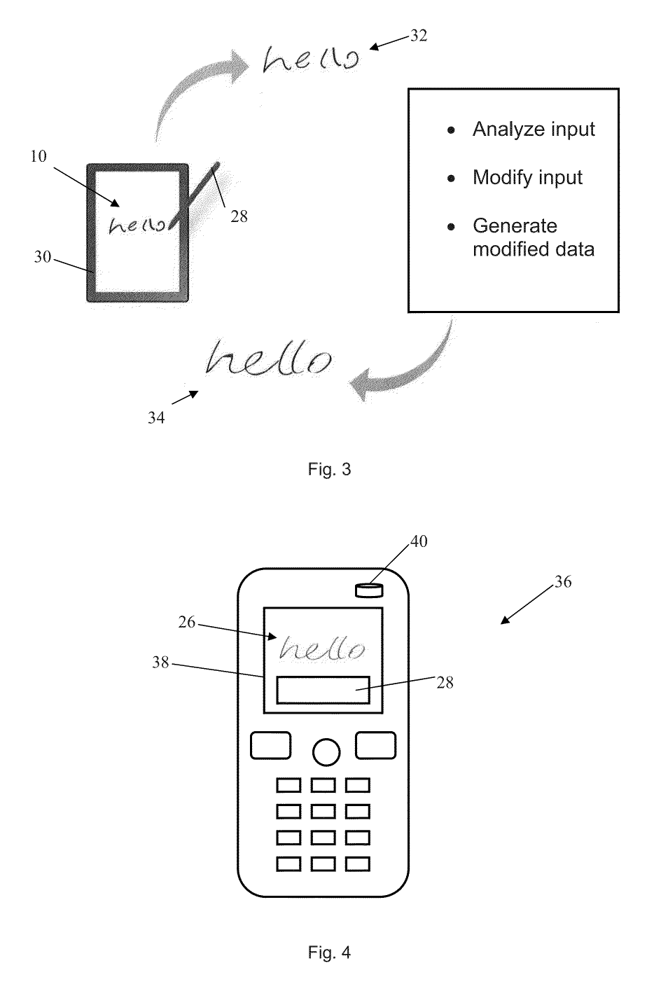

FIG. 3 shows a method according to an embodiment of the present invention. A user firstly inputs a section of handwriting 10 using a stylus 28 and a touch sensitive screen 30 of a device according to an embodiment of the present invention. A software application then interprets the movements of the stylus across the writing surface, translating the resulting strokes into digital text. Alternatively, rather than a user inputting handwriting, input representative of at least one section of handwriting, such as the bitmap of recorded pixels 32, may be received by a device according to the present invention from another device, such as a mobile telephone, computer of file server. The bitmap 32 is analyzed by determining at least one characteristic of the inputted handwriting 10. The input is modified and a modified vector 34 is generated. Modified on-screen handwriting may then be displayed on the touch sensitive screen 30 and/or some other display means.

FIG. 4 shows an electronic device 36, namely a mobile phone, comprising a device according to an embodiment of the invention. The device 34 comprises a display screen 38 for displaying modified on-screen handwriting 26. According to an embodiment of the invention at least part (28) of the display screen 38 may be used to input handwriting. The device 34 also comprises storage means 40 for storing modified on-screen handwriting data.

A device according to an embodiment of the invention may for example be used in a lecture theatre or classroom to make a lecturer's/teachers handwriting easier to read. A lecturer's/teacher's modified handwriting may for example be inputted into a device, such as a handheld electronic tablet, analyzed and modified by a device according to the invention and then displayed on projector means for his/her students/pupils. Further modifications of the invention within the scope of the claims would be apparent to a skilled person.

1. A device for analyzing and modifying on-screen handwriting, configured to:
determine at least one characteristic of at least one section of handwriting,
modify said at least one characteristic, and
generate modified on-screen handwriting data.

2. The device according to claim 1, comprising:
means for inputting said at least one section of handwriting.

3. The device according to claim 1, wherein the device is further configured to:
receive input representative of said at least one section of handwriting.

4. The device according to claim 1, wherein the device is further configured to:
effect displaying of modified on-screen handwriting.

5. The device claim 1, further comprising:
means to display modified on-screen handwriting.

6. The device according claim 1, wherein the device is further configured to:
effect storing of said modified on-screen handwriting data.

7. The device according to claim 1, wherein said at least one characteristic is selected from a group comprising: letter symbol/angles, letter/symbol spacings, letter/symbol loops, letter/symbol size, word spacings, line spacings, stroke style, stroke weight, and baseline position.

8. The device according to claim 1, wherein the device comprises at least one of a mobile telephone, media player, Personal Communications System (PCS) terminal, Personal Data Assistant (PDA), laptop computer, palm top receiver, a file server, camera, television, radar or an appliance that includes a transducer designed to transmit and/or receive radio, television, telephone and/or radar signals.

9. A method for analyzing and modifying on-screen handwriting, comprising:
determining at least one characteristic of at least one section of handwriting,
modifying said at least one characteristic, and
generating modified on-screen handwriting data.

10. The method of claim 9, further comprising:
inputting said at least one section of handwriting.

11. The method of claim 9, further comprising:
receiving input representative of said at least one section of handwriting.

12. The method of claim 9, further comprising:
effecting displaying of modified on-screen handwriting.

13. The method of claim 9, further comprising:
storing said modified on-screen handwriting data.

14. The method of claim 9, wherein said at least one characteristic is selected from the group comprising: letter symbol/angles, letter/symbol spacings, letter/symbol loops, letter/symbol size, word spacings, line spacings, stroke style, stroke weight, and baseline position.

15. A computer program product, comprising a computer program containing computer program code means arranged to cause a computer or a processor to execute the method of claim 9, wherein the computer program product is stored on a tangible computer-readable medium.
